(19) United States
(12) Patent Application Publication
(10) Pub. No.: US 2025/0363356 A1
(43) Pub. Date: Nov. 27, 2025

(54) PHYSICS-CONSTRAINED DEEP LEARNING JOINT INVERSION

(71) Applicant: SAUDI ARABIAN OIL COMPANY, Dhahran (SA)

(72) Inventors: Daniele Colombo, Dhahran (SA); Weichang Li, Katy, TX (US); Diego Rovetta, Delft (NL)

(73) Assignee: SAUDI ARABIAN OIL COMPANY, Dhahran (SA)

(21) Appl. No.: 19/287,340

(22) Filed: Jul. 31, 2025

Related U.S. Application Data
(63) Continuation of application No. 17/121,044, filed on Dec. 14, 2020.
(60) Provisional application No. 62/980,060, filed on Feb. 21, 2020.

(51) Int. Cl. G06N 3/08; E21B 47/00; G06N 3/045

(52) U.S. Cl. CPC G06N 3/08; G06N 3/045; E21B 47/00; E21B 2200/22

(57) ABSTRACT

A deep learning framework includes a first model for predicting one or more attributes of a system; a second model for predicting one or more attributes of the system; at least one coupling operator combining the first and second models; and at least one inversion module for receiving the combined first and second models from the coupling operator. The inversion module simultaneously optimizes the first model and the second model, thereby resulting in a composite objective function representative of a prediction that is outputted to at least one user.

### BACKGROUND

Reservoir monitoring is an operation involving the mapping of fluid movements within the reservoir as a consequence of oil production. The capabilities of mapping and monitoring the evolution of the saturations in the reservoir by estimating the saturations away from the well (i.e., in the interwell space) provide better knowledge of where to drill new wells to drain the oil in the reservoir, or, in other words, to optimize field development.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a deep learning framework. The framework includes a first model for predicting one or more attributes of a system, a second model for predicting one or more attributes of the system, at least one coupling operator combining the first and second models, and at least one inversion module for receiving the combined first and second models from the at least one coupling operator, wherein the at least one inversion module simultaneously optimizes the first model and the second model, thereby resulting in a composite objective function representative of a prediction that is outputted to at least one user.

In general, in one aspect, embodiments relate to a method of training a neural network. The method includes inputting data into a model, pre-processing the data, defining an input data structure, defining at least one output parameter around which the neural network is optimized, creating test and training data sets from data input into the model, training the model, and updating the model based at least partially on new data that is inputted into the model after the model has been trained.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments.

FIG. 2 shows a simplified inversion or optimization framework in accordance with one or more embodiments.

FIGS. 3A-3B show invention flow diagrams in accordance with one or more embodiments.

FIG. 4 shows an example in accordance with one or more embodiments.

FIGS. 5-6 show invention flow diagrams in accordance with one or more embodiments.

FIGS. 7-8, 9A-9D, and 10-11 show examples in accordance with one or more embodiments.

FIG. 12 shows a flowchart in accordance with one or more embodiments.

FIGS. 13A-13B and 14-20 show examples in accordance with one or more embodiments.

FIGS. 21A-21B show a computing system in accordance with one or more embodiments.

Like elements in the various figures are denoted by like reference numerals for consistency.

### DETAILED DESCRIPTION

Specific embodiments of the disclosure will now be described in detail with reference to the accompanying figures.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In order for the present disclosure to be more readily understood, certain terms are first defined below. Additional definitions for the following terms and other terms are set forth throughout the specification.

An apparatus, composition, or method described herein as “comprising” one or more named elements or steps is open-ended, meaning that the named elements or steps are essential, but other elements or steps may be added within the scope of the composition or method. To avoid prolixity, it is also understood that any apparatus, composition, or method described as “comprising” (or which “comprises”) one or more named elements or steps also describes the corresponding, more limited composition or method “consisting essentially of” (or which “consists essentially of”) the same named elements or steps, meaning that the composition or method includes the named essential elements or steps and may also include additional elements or steps that do not materially affect the basic and novel characteristic(s) of the composition or method. It is also understood that any apparatus, composition, or method described herein as “comprising” or “consisting essentially of” one or more named elements or steps also describes the corresponding, more limited, and closed-ended composition or method “consisting of” (or “consists of”) the named elements or steps to the exclusion of any other unnamed element or step. In any composition or method disclosed herein, known or disclosed equivalents of any named essential element or step may be substituted for that element or step.

As used herein, the terms “neural network” and “correlation matrix” may be used interchangeably and may refer to systems and methods that relate at least one input parameter to at least one output parameter of a system, and quantify such relationships between input and output parameters. Neural networks and correlation matrices may be built autonomously via one or more computer-implemented systems, and may also be built in connection with one or more human inputs.

As used herein, the term “inversion” may be used synonymously with the term “optimization.”

As used herein, the terms “machine-learning”, “artificial intelligence,” “cognitive reasoning,” “autonomous systems,” “adaptive algorithms,” “deep learning,” and “heuristics” may all describe systems, methods, protocols, and apparatuses that search for and establish correlations that are at least partially predictive of at least one output or result, at least some percent of the time, without requiring previous programming or instruction for every executable step, and without needing to be 100% predictive in every situation.

As used herein, “a” or “an” with reference to a claim feature means “one or more,” or “at least one.”

As used herein, the term “substantially” refers to the qualitative condition of exhibiting total or near-total extent or degree of a characteristic or property of interest.

Oil production is performed in most cases by injecting fluids through injector wells, possibly at the periphery of the reservoir, to sweep the oil in place and sustain pressure at producing wells. These recovery operations are typically classified as primary recovery (spontaneous), secondary (e.g. waterflooding) or enhanced oil recovery operations (EOR) (e.g. CO₂ injection, for example). The injected fluid displaces the oil in place by pushing it toward the producers. The rock formations where the oil is stored are far from being homogeneous so that the prediction of how the injected fluid moves underground (and how the oil is displaced) is uncertain and can only be predicted to a certain degree by mathematical models such as fluid flow simulators (or reservoir simulators). Direct measurements of the oil-water saturations and column thickness can be performed in wells. Injected tracers can also be detected and quantified from well fluid samples. Existing patterns of wells are, in most cases, insufficient to provide a comprehensive mapping capability of fluid distribution in the inter-well space.

Remote sensing techniques such as geophysical methods (e.g., seismic, gravity, electromagnetics) rely on the measurement of “fields” (e.g., travel-time/amplitudes, gravity acceleration, electric/magnetic fields) from remote locations such as the surface or other boreholes. Physics provide the knowledge of the relations between rock properties (e.g., P-velocity/S-velocity, density, resistivity, porosity, saturations, etc.) and corresponding measured fields given certain conditions (e.g., geometry of acquisition, other rock properties, etc.). The mathematical modeling of such fields given some prior property distribution (e.g., by finite difference-FD, finite element-FE, finite volume method-FVM, etc. techniques), provide the mechanism of mapping/locating specific properties into the model by means of a process called geophysical inversion or generically inversion methods.

In general, embodiments of the disclosure include systems and methods for implementing a hybrid scheme of physics-driven inversion and statistical case-driven machine learning (deep learning) inversion for implementing multi-parameter joint inversion or optimization. The systems and methods include the simultaneous estimation of multiple model parameters through an inversion process where observed measurements (data space/input) are converted to multiple property distributions (parameter or model space/output) where a performance criterion is optimized. An inversion may be performed using standard inversion theory and may be implemented, for example, through a linearized inversion approach which is driven by physics. Alternatively, an inversion may be performed via a purely statistical approach using machine learning/deep learning methods, where a neural network is first trained with examples to optimize the network parameters (hyperparameters consisting of weights and biases), and then used to predict parameter distributions given a finite number of inputs and/or observed measurements.

The physics-driven (or model-based) inversion and the data-driven (or statistics-based) inversion represent alternative methods to solve a similar problem. One implementation of a standard inversion theory uses primarily a representation of physics processes to solve a forward problem leading to predicted measurements. The measurements may then be compared with the observed data to project the residuals into the model space through the inversion process. The statistical deep learning approach uses several cases provided by the user to train a neural network and determine dependencies and correlations between observed data and parameter distributions (models). Once the training is performed, the deep learning neural network converts the measurements into models in the prediction phase. These two approaches are based on very different principles, having their own advantages and weaknesses. The present disclosed embodiments include algorithms and workflows for implementing a reciprocal feedback loop to merge the two approaches together in a unified procedure via a fully functional feedback loop between the physics-driven and statistical case-driven inversions, which allow for the exploitation of the benefits from both inversion approaches. The present disclosed embodiments may include multi-parameter, simultaneous inversion or joint inversion.

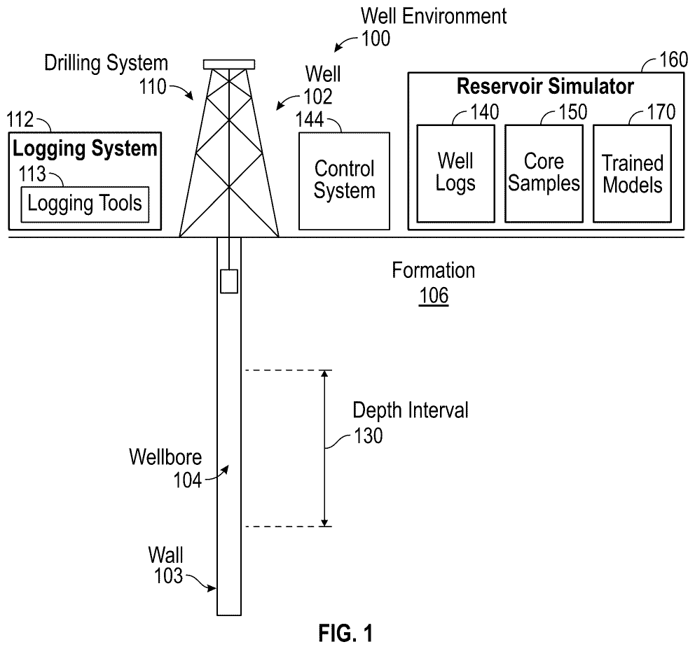

FIG. 1 shows a schematic diagram in accordance with one or more embodiments. FIG. 1 illustrates a well environment (100) that may include a well (102) with a wall (103) having a wellbore (104) extending into a formation (106). The wellbore (104) may include a bored hole that extends from the surface into a target zone of the formation (106), such as a reservoir (not shown). The formation (106) may include various formation characteristics of interest, such as formation porosity, formation permeability, resistivity, water saturation, and free water level (FWL). Porosity may indicate how much void space exists in a particular rock within an area of interest in the formation (106), where oil, gas or water may be trapped. Permeability may indicate the ability of liquids and gases to flow through the rock within the area of interest. Resistivity may indicate how strongly rock or fluid within the formation (106) opposes the flow of electrical current. For example, resistivity may be indicative of the porosity of the formation (106) and the presence of hydrocarbons. More specifically, resistivity may be relatively low for a formation that has high porosity and a large amount of water, and resistivity may be relatively high for a formation that has low porosity or includes a large amount of hydrocarbons. Water saturation may indicate the fraction of water in a given pore space.

Keeping with FIG. 1, the well environment (100) may include a drilling system (110), a logging system (112), a control system (144), and a reservoir simulator (160). The drilling system (110) may include a drill string, drill bit or a mud circulation system for use in boring the wellbore (104) into the formation (106). The control system (144) may include hardware or software for managing drilling operations or maintenance operations. For example, the control system (144) may include one or more programmable logic controllers (PLCs) that include hardware or software with functionality to control one or more processes performed by the drilling system (110). Specifically, a programmable logic controller may control valve states, fluid levels, pipe pressures, warning alarms, or pressure releases throughout a drilling rig. In particular, a programmable logic controller may be a ruggedized computer system with functionality to withstand vibrations, extreme temperatures (for example, ˜575° C.), wet conditions, or dusty conditions, for example, around a drilling rig. Without loss of generality, the term “control system” may refer to a drilling operation control system that is used to operate and control the equipment, a drilling data acquisition and monitoring system that is used to acquire drilling process and equipment data and to monitor the operation of the drilling process, or a drilling interpretation software system that is used to analyze and understand drilling events and progress.

The logging system (112) may include one or more logging tools (113), such as a nuclear magnetic resonance (NMR) logging tool or a resistivity logging tool, for use in generating well logs (140) of the formation (106). For example, a logging tool may be lowered into the wellbore (104) to acquire measurements as the tool traverses a depth interval (130) (for example, targeted reservoir section) of the wellbore (104). The plot of the logging measurements versus depth may be referred to as a “log” or “well log”. Well logs (104) may provide depth measurements of the well (102) that describe such reservoir characteristics as formation porosity, formation permeability, resistivity, water saturation, and the like. The resulting logging measurements may be stored or processed or both, for example, by the control system (144), to generate corresponding well logs (140) for the well (102). A well log may include, for example, a plot of a logging response time versus true vertical depth (TVD) across the depth interval (130) of the wellbore (104).

Reservoir characteristics may be determined using a variety of different techniques. For example, certain reservoir characteristics can be determined via coring (for example, physical extraction of rock samples) to produce core samples (150) or logging operations (for example, wireline logging, logging-while-drilling (LWD) and measurement-while-drilling (MWD)). Coring operations may include physically extracting a rock sample from a region of interest within the wellbore (104) for detailed laboratory analysis. For example, when drilling an oil or gas well, a coring bit may cut plugs (or “cores”) from the formation (106) and bring the plugs to the surface, and these core samples may be analyzed at the surface (for example, in a lab) to determine various characteristics of the formation (106) at the location where the sample was obtained. One example of a reservoir characteristic is the amount of oil present in the reservoir, and monitoring or observing the depletion of oil from the reservoir. Reservoir monitoring is an operation involving the mapping of fluid movements within the reservoir as a consequence of oil production.

Multiple types of logging techniques are available for determining various reservoir characteristics, and a particular form of logging may be selected and used based on the logging conditions and the type of desired measurements. For example, NMR logging measures the induced magnetic moment of hydrogen nuclei (that is, protons) contained within the fluid-filled pore space of porous media (for example, reservoir rocks). Thus, NMR logs may measure the magnetic response of fluids present in the pore spaces of the reservoir rocks. In so doing, NMR logs may measure both porosity and permeability as well as the types of fluids present in the pore spaces. For determining permeability, another type of logging may be used that is called spontaneous potential (SP) logging. SP logging may determine the permeabilities of rocks in the formation (106) by measuring the amount of electrical current generated between a drilling fluid produced by the drilling system (110) and formation water that is present in pore spaces of the reservoir rock. Porous sandstones with high permeabilities may generate more electricity than impermeable shales. Thus, SP logs may be used to identify sandstones from shales.

To determine porosity in the formation (106), various types of logging techniques may be used. For example, the logging system (112) may measure the speed that acoustic waves travel through rocks in the formation (106). This type of logging may generate borehole compensated (BHC) logs, which are also called sonic logs and acoustic logs. In general, sound waves may travel faster through shales than through sandstones because shales generally have greater density than sandstones. Likewise, density logging may also determine porosity measurements by directly measuring the density of the rocks in the formation (106). In addition, neutron logging may determine porosity measurements by assuming that the reservoir pore spaces within the formation (106) are filled with either water or oil and then measuring the amount of hydrogen atoms (that is, neutrons) in the pores. Furthermore, the logging system (112) may determine geological data for the well (102) by measuring corresponding well logs (140) and data regarding core samples (150) for the well (102).

Keeping with the various types of logging techniques, resistivity logging may measure the electrical resistivity of rock or sediment in and around the wellbore (104). In particular, resistivity measurements may determine what types of fluids are present in the formation (106) by measuring how effective these rocks are at conducting electricity. Because fresh water and oil are poor conductors of electricity, they have high relative resistivities. For example, an electrical resistivity of oil ranges from 4.5455×10⁶ to 1.4925×10⁸ ohm-meter and the electrical resistivity of fresh water aquifers is in the range of 10-100 ohm-meter. As such, resistivity measurements obtained via such logging can be used to determine corresponding reservoir water saturation (S_{w}).

Turning to the reservoir simulator (160), the reservoir simulator (160) may include hardware or software with functionality for generating one or more trained models (170) regarding the formation (106). For example, the reservoir simulator (160) may store well logs (140) and data regarding core samples (150), and further analyze the well log data, the core sample data, seismic data, or other types of data to generate or update the one or more trained models (170) having a complex geological environment. For example, different types of models may be trained, such as artificial intelligence, convolutional neural networks, deep neural networks, support vector machines, decision trees, inductive learning models, deductive learning models, and supervised learning models, and are capable of approximating solutions of complex non-linear problems. The reservoir simulator (160) may couple to the logging system (112) and the drilling system (110).

In some embodiments, the reservoir simulator (160) may include functionality for applying deep learning or artificial intelligence methodologies to precisely determine various subsurface layers. To do so, a large amount of interpreted data may be used to train a model. To obtain this amount of data, the reservoir simulator (160) may augment acquired data for various geological scenarios and drilling situations. For example, drilling logs may provide similar log signatures for a particular subsurface layer except where a well encounters abnormal cases. Such abnormal cases may include, for example, changes in subsurface geological compositions, well placement of artificial materials, or various subsurface mechanical factors that may affect logging tools. As such, the amount of well data with abnormal cases available to the reservoir simulator (160) may be insufficient for training a model. Therefore, in some embodiments, a reservoir simulator (160) may use data augmentation to generate a dataset that combines original acquired data with augmented data based on geological and drilling factors. This supplemented dataset may provide sufficient training data to train a model accordingly.

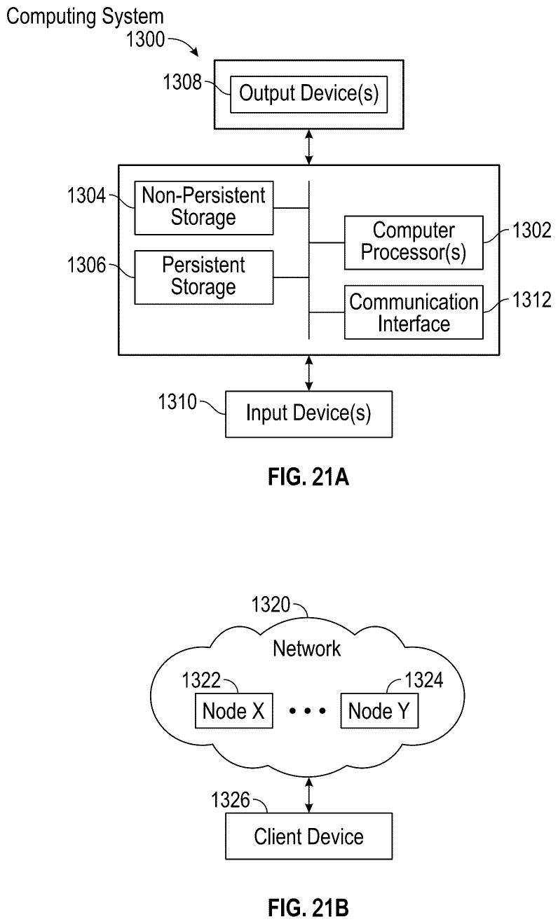

In some embodiments, the reservoir simulator (160) is implemented in a software platform for the control system (144). The software platform may obtain data acquired by the drilling system (110) and logging system (112) as inputs, which may include multiple data types from multiple sources. The software platform may aggregate the data from these systems (110, 112) in real time for rapid analysis. Real-time of or relating to computer systems in the software platform is defined as the actual time for updating information with instantaneous processing at the same rate as required by a user or necessitated by a process being controlled. In some embodiments, the control system (144), the logging system (112), or the reservoir simulator (160) may include a computer system that is similar to the computer system (700) described with regard to FIGS. 21A and 21B and the accompanying description.

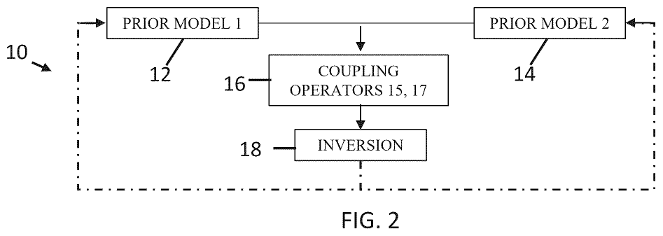

FIG. 2 illustrates a simplified inversion or optimization framework (10) that includes multiple physics-driven models. The simplified framework (10) may include a first prior physics-based model (12), and a second prior physics-based model (14) which may be combined into a single inversion (18) via one or more coupling operators (16). The coupling operators (16) may include a first coupling operator (15) based on structure and/or gradients of each of the first and second models (12, 14), as well as a second coupling operator (17) based on the physics, rules, or properties of the underlying medium being modeled (that is, in the first and second models (12, 14)). The first coupling operator (15) may include shape constraints and/or other geometric or structural details (for example physical boundaries or dimensions) common to each of the first and second models (12, 14). The second coupling operator (17) may be regression based and may focus on properties of the medium, object, or system being modeled (for example, (i) mechanical or physical properties of a geologic formation; (ii) aerodynamic, thermodynamic, and fluid properties of air in a gas turbine engine or internal combustion engine; (iii) hydrodynamic, chemical, and/or thermal properties of an ocean model; as well as other possible systems and models including rules based on biology, chemistry, physics, material science, economics, geology, meteorology, psychology, medicine, neurology, seismology, electronics, pharmacology, ecology, astrophysics, hydrology, particle physics, science, engineering, and other fields of study). The coupling operators (16) may also include third, fourth, fifth, and other numbers of coupling operators (16). The simplified framework 10 may also include an inversion (18) that performs simultaneous error minimization operations on both of the first and second models (12, 14) via the coupling operators (16) in order to achieve a composite optimization based on both the first and second models (12, 14).

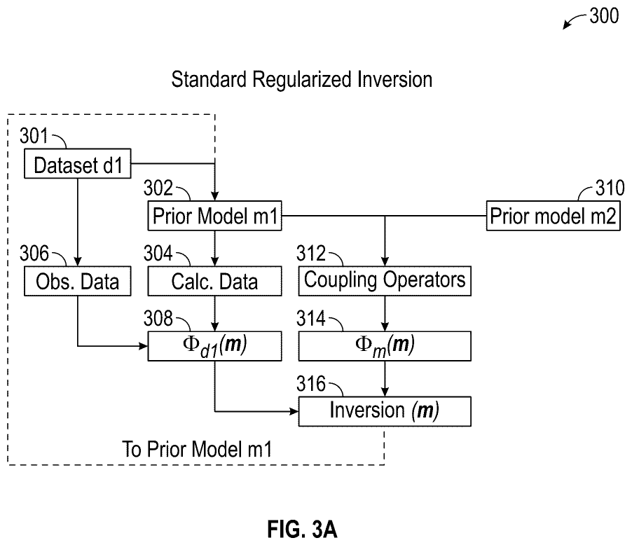

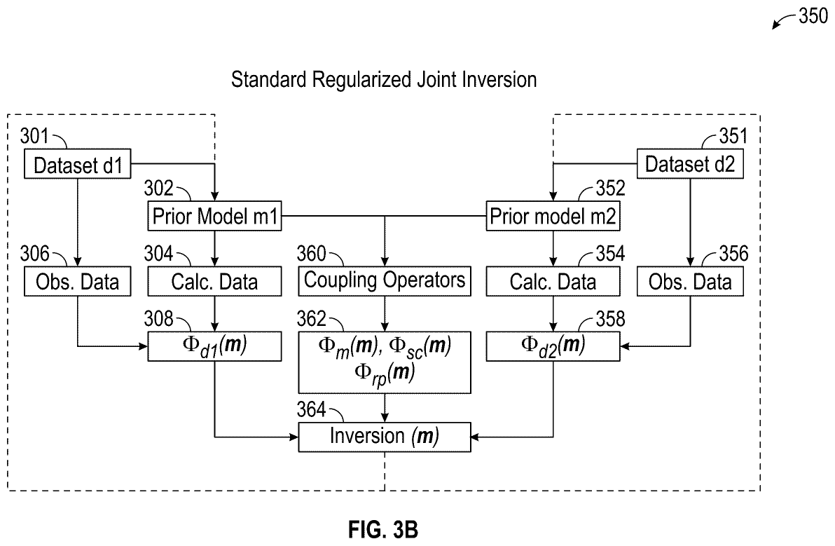

FIGS. 3A and 3B illustrate inversion flow diagrams in accordance with one or more embodiments. Turning to FIG. 3A, FIG. 3A describes a general scheme for a physics-driven standard regularized inversion based on linear algebra for a single model parameter. The process typically starts from a dataset d1 (301) and a prior model (initial model/prior model 1) (302) that is used to calculate predicted data through a forward operator. The difference between calculated (304) and observed data (306) is used to build a data misfit objective function (ϕ_{d1}) (308) where the linearized form of the forward data residual is differentiated towards the parameters of the model. The forward operator provides the sensitivity of the data to the model parameters. The regularization of the inversion can be performed by using a reference model (prior model 2) (310) that is used to link the model parameters resulting from the minimization of ϕd1 (308) to some a-priori knowledge of the model parameters (reference model) using a coupling operator (312). This is expressed by an objective function ϕₘ (314). The model objective function can also contain other regularization mechanisms acting on the model parameters such as a Laplacian smoothness (or other functions), a covariance matrix, gradient-based coupling operators (cross-gradient, summative gradients), rock-physics coupling operators, etc. (i.e., generically called “penalty functions”). The penalty function can take various forms, for example, model reference, cross-gradient, summative gradient, and rock physics. The simultaneous minimization of ϕ_{d1} and ϕₘ provides model parameters that are honoring the data misfit minimization subject to external constraints acting on the model. In one or more embodiments, weights may also be introduced to balance how much one or the other term would prevail during the minimization. The model parameters (prior model 1) are then updated with the results of the inversion (316) and a new inversion iteration is started. The iterative process is stopped when one or multiple criteria are met in the minimization of the composite objective function.

Turning to FIG. 3B, FIG. 3B describes a general scheme for a physics-driven standard regularized inversion based on linear algebra for a case of joint inversion (of multiple model parameters) in accordance to one or more embodiments.

Joint Inversion Scheme: A model space characterized by the model vector m=[m₁, m₂] consisting of property components from different geophysical domains is defined. A data space by d= [d₁, d₂] obtained from different geophysical measurements (for simplicity only two domains are considered in this example) is defined. A joint inversion (JI) algorithm can be formulated as a constrained least squares problem solved by minimizing a composite objective function consisting of a data misfit, a model regularization function, and two inter-domain coupling operators: structure (e.g., gradient based), constraining the shapes, and rock-physics (e.g., regression based), constraining the property values:

$${ϕ}_{t} ( m ) = {ϕ}_{d} ( m ) + {μ}_{1} {ϕ}_{m} ( m ) + {μ}_{2} {ϕ}_{x} ( m ) + {μ}_{3} {ϕ}_{rp} ( m ) , \qquad ( 1 )$$

where μᵢ, i=1, . . . 3 are misfit weights.

The data misfit is defined as:

$${ϕ}_{d} ( m ) = {( J m - {d}_{obs} )}^{T} {W}_{d}^{T} {W}_{d} ( J m - {d}_{obs} ) = {‖ {W}_{d} ( J m - {d}_{obs} ) ‖}_{{L}_{2}}^{2} , \qquad ( 2 )$$

where d_{obs} is the vector of the observed data, J is the Jacobian or the sensitivity matrix, and W_{d} is a data weighting (or covariance) matrix taking into account the relative importance of the observations and the effect of the noise in the data.

The model regularization function ϕₘ (m) is defined as:

$${ϕ}_{m} ( m ) = {( m - {m}_{0} )}^{T} {W}_{m}^{T} {W}_{m} ( m - {m}_{0} ) = {‖ {W}_{m} ( m - {m}_{0} ) ‖}_{{L}_{2}}^{2} , \qquad ( 3 )$$

where m₀ is the prior model and Wm is a model weighting matrix (and Wₘ^{T}Wₘ the equivalent inverse covariance). The two remaining misfit terms, ϕₓ(m) and ϕᵣₚ(m) are the structure and rock-physics operators, which make ϕₜ(m) a joint inversion objective function.

The process typically start for the case of one inversion iteration for two model parameter distributions where the model parameters can be of different nature, for example seismic velocity and resistivity. The overall scheme of the joint inversion is not changing by increasing the number of parameters. In a standard regularized joint inversion approach (350), more coupling operators (360) are introduced that are of statistical nature. In particular a coupling operator linking the shape of the parameter distribution is used (structure operator: ϕ_{sc} and often based on functions of model gradients (cross product: cross gradients, normalized sum: summative gradients, other), and a rock-physics operator (ϕᵣₚ) linking the parameter values. Often the rock-physics operators are the result of some non-linear regression function fitting a cross-plot of the parameters. Other rock-physics operators can be obtained from other analytical or empirical relations.

In one or more embodiments, weights (or Lagrange multipliers) are typically assigned to the different terms of the objective function to balance the effects of the different components. The joint inversion is performed simultaneously (simultaneous minimization of all the terms—type BB, as shown in FIG. 3B) or by alternating different datasets and keeping the coupling operators in the joint minimization (type AA, as shown in FIG. 3A). As for the previous case (300), the model objective function can also contain other regularization mechanisms acting on the model parameters such as a Laplacian smoothness (or other functions), a covariance matrix, etc. Equations (2) and (3) detail the data misfit function and the model misfit function. All the terms of the composite objective function act on the model parameters (m). The model parameters (prior model 1 (302) and 2 (352)) are then updated with the results of the inversion and a new inversion iteration is started. The iterative process is stopped when one or multiple criteria are met in the minimization of the composite objective function.

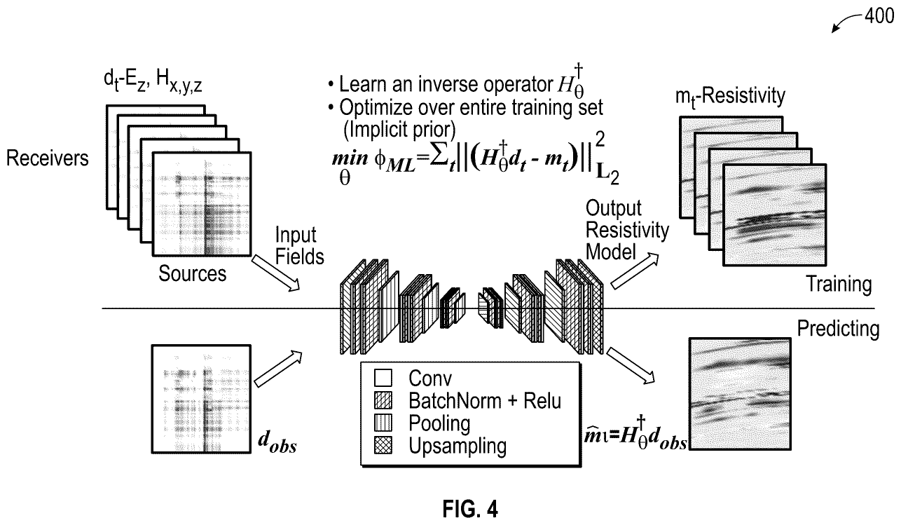

Turning to FIG. 4, FIG. 4 shows an example (400) of a deep learning neural network in accordance with one or more embodiments. The deep learning neural net is characterized by a contracting path (encoding) and an expansive path (decoding). Each level is composed by a stack of hidden layers characterized by sequential operations of convolution, batch normalization, activation function (for example, Rectified Linear Unit-ReLU) and max-pooling. The output of the sequence becomes the input of another sequence with decreased dimensionality and increased filter depth. As a result, the spatial information along the contraction path is reduced while the extracted feature information is enriched. The expansive path combines the feature and spatial information through a sequence of upsampling and concatenations of the features obtained from the contracting path, with increasing resolution.

Deep Learning Inversion Scheme: The output o of a neural network can be expressed as a nonlinear function h of the input i and of the network hyperparameters (weights and biases) θ:

$$o = h ( i , θ ) . \qquad ( 4 )$$

The previous equation can be used to train the network for an inverse problem by assuming the input dt and the output mt, and minimizing a least squares deep learning (DL) objective function (i.e., loss function) over the network parameters θ.

$${ϕ}_{l , m} = {‖ {H}_{θ}^{†} {d}_{t} - {m}_{t} ‖}_{{L}_{2}}^{2} , \qquad ( 5 )$$

where the term

$${H}_{θ}^{†}$$

is a pseudoinverse operator parameterized by θ. The loss function ϕ_{l,m} is minimized to obtain an optimized set of network parameters θ. The trained network is then used to predict the output mₗ from new observed data d_{obs} through the optimized pseudoinverse operator H_{θ}^{†}:

$${m}_{l} = {H}_{θ}^{†} {d}_{obs} \qquad ( 6 )$$

The predicted model mᵢ can be embedded in an inversion scheme.

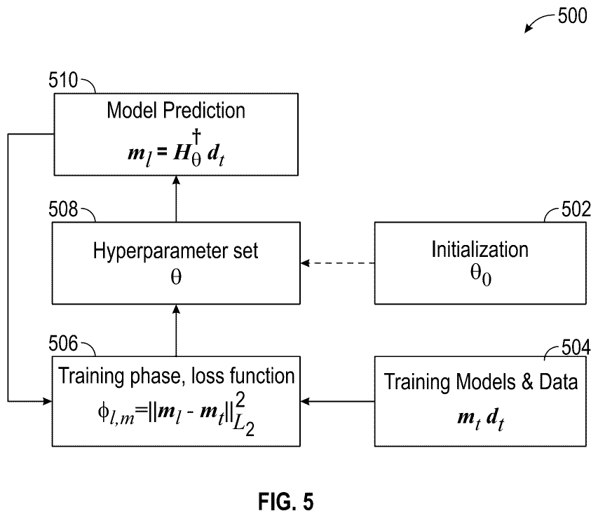

Deep learning inversion (type CC, in FIG. 5) is statistics-based meaning that the pseudoinverse operator

$${H}_{θ}^{†}$$

is learned directly from the data through extensive training of the deep learning neural network using synthetic modeling and/or past experience. The deep learning inversion is composed by two steps consisting of a training phase where the network hyperparameters θ are learned from input data and models, and a testing phase (prediction) where the optimized pseudoinverse operator (parameterized by θ) is used to predict the models using observed data. The mechanism used for optimizing the network hyperparameters θ is by means of the minimization of an objective function (equation 5) typically called “loss function” which measures the discrepancy between predicted models with current hyperparameters θ

$$( {H}_{θ}^{†} {d}_{t} )$$

and the corresponding known models provided for the training (mₜ).

The case depicted in FIG. 4 represents an application to electromagnetic (EM) inversion where the input EM fields data (vertical electric field E_{z}, three component magnetic field H_{x,y,z}) are used to train a deep learning network to predict resistivity distributions (mₗ).

Turning to FIG. 5, the statistics-based deep learning inversion (500) is represented as a flow diagram. Referring to equation 4, the output of a neural network can be expressed as a nonlinear function of the input and of the network hyperparameters θ (consisting of weights and biases). Starting from some initialization of the hyperparameter set θ (502) (i.e. θ₀), an objective/loss function is setup where the difference between the predicted models mₗ (510) from the deep learning network

$$( {m}_{l} = {H}_{θ}^{†} {d}_{t} - i . e . , equation 6 )$$

and the known models mₜ (504) is evaluated

$$( {ϕ}_{l , m} = {‖ {m}_{l} - {m}_{t} ‖}_{{L}_{2}}^{2} ) ( 556 ) .$$

The least-squares (LS) minimization of the loss function (ϕ_{l,m}) allows to obtain optimized θ parameter sets. The new network parameters are used for model prediction through equation 6. The procedure is then iterated through additional loss function evaluation and parameter optimization until a stopping criteria is reached.

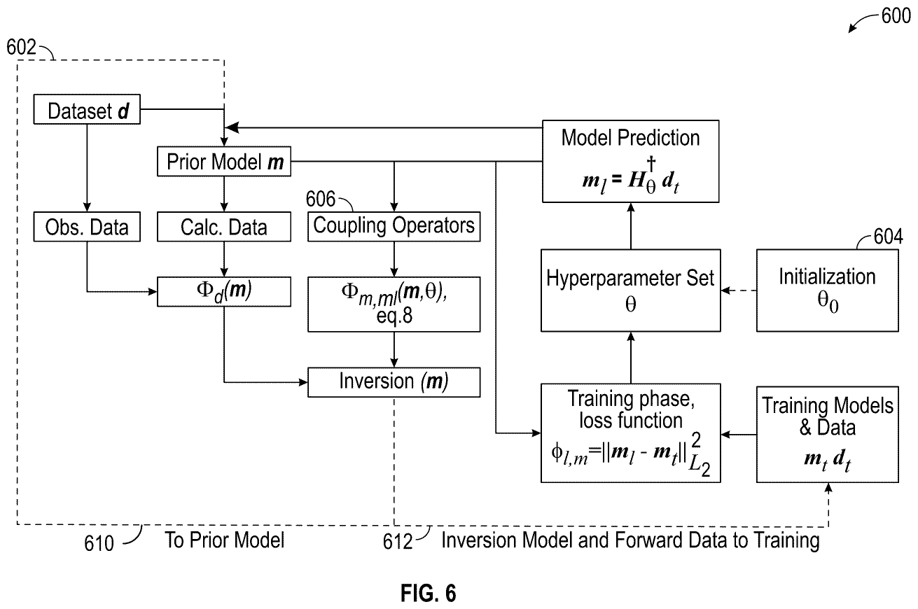

Turning to FIG. 6, FIG. 6 describes an invention flow diagram of a physics-driven deep learning-based inversion in accordance to one or more embodiments.

Physics-Driven Deep Learning Inversion/Joint Inversion: The deep learning joint inversion objective function can be written as:

$${ϕ}_{t} ( m , θ ) = {ϕ}_{d} ( m ) + {μ}_{1} {ϕ}_{l , m} ( θ ) + {μ}_{2} {ϕ}_{m , ml} ( m , θ ) , \qquad ( 7 )$$

$$where :$$

$${ϕ}_{d} ( m ) is as ( 2 ) ,$$

$${ϕ}_{l , m} ( θ ) is as ( 5 ) ,$$

$${ϕ}_{m , ml} ( m , θ ) = {‖ {W}_{m} ( m - {m}_{l} ( θ ) ) ‖}_{{L}_{2}}^{2} . \qquad ( 8 )$$

Equation (7) can then be solved using alternative minimizations as follows:

$${m}^{k} = arg {min}_{m} {ϕ}_{t} ( m , {θ}^{k - 1} ) = {ϕ}_{d} ( m ) + {μ}_{2} {ϕ}_{m , ml} ( m , {θ}^{k - 1} ) , \qquad ( 9 )$$

$${θ}^{k} = arg {min}_{θ} {‖ {H}_{θ}^{†} {d}_{t} - {m}^{k} ‖}_{{L}_{2}}^{2} , \qquad ( 10 )$$

where equation (9) can be solved via traditional regularized inversion and equation (10) using deep learning retraining.

Turning to FIG. 6, the physics-based optimization (602) is joined with the statistics-based deep learning inversion (604) through a coupling operator (606) linking the model parameters that are predicted by both procedures (type DD, as shown in FIG. 6). Here, it is assumed that the data vector d and the model vector m are expressing multiple data types and multiple model parameters (e.g. seismic velocity, resistivity, density, etc. and associated measured responses, i.e. data). The scheme as shown in FIG. 6 where the output of the deep learning network prediction mₗ is used to constrain the physics-based inversion through a model reference objective function. The model reference misfit function Φ_{m,ml} (m, θ), equation 8, is used to enforce a similarity between the models obtained from the two distinct procedures. The model reference term is acting as a coupling operator where the structure and rock-physics operators of equation 1 may now be implicitly learned through the deep learning neural network and may not need to appear as separate terms in the deep learning joint inversion objective function (equation 7). One additional property of the flow diagram (600) depicted in FIG. 6 is the feedback loop (612) for re-training the neural network. The output of the deep learning joint inversion procedure (i.e., inversion model and corresponding forward modeled data (612)) are added to the training dataset for further re-training of the network. The results of the inversion are also sent to update the prior model of the physics-based inversion (602). In some embodiments, the output of the deep learning network prediction mₗ can also be optionally used as “prior” model other than as the coupling operators. For example, this can be done at the first iteration of the inversion process where instead than to start from some undefined “guess” of the prior, we can use the deep learning network prediction as starting model.

These operations are performed through alternative minimizations as per equations 9 and 10. The two competing procedures will converge to a common model incorporating at the same time physics-based and deep learning, statistics-based inversions.

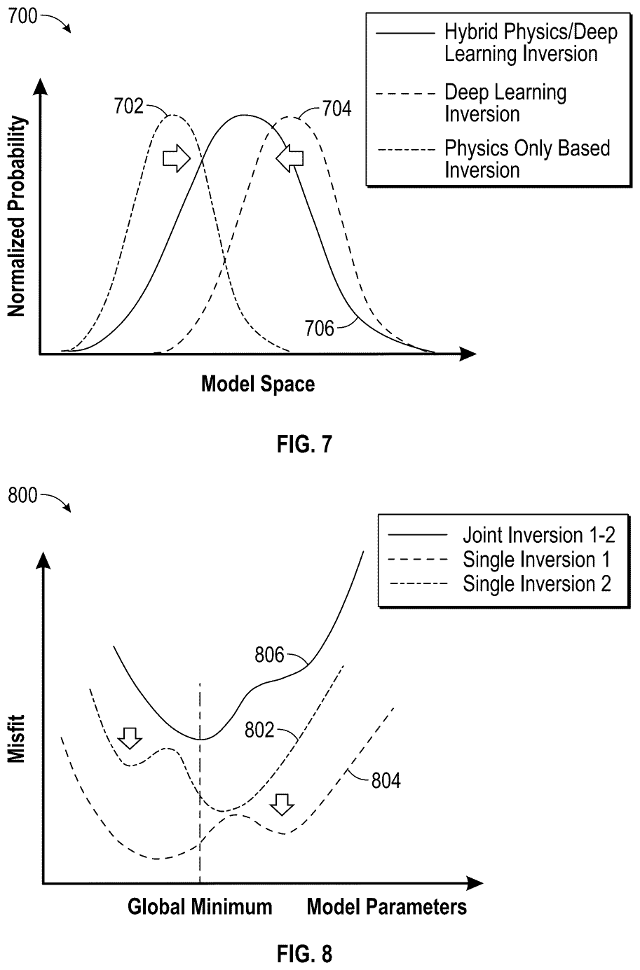

FIGS. 7 and 8 provide examples in accordance with one or more embodiments. The following examples are for explanatory purposes only and are not intended to limit the scope of the disclosed technology.

Turning to FIG. 7, FIG. 7 shows an example graph (700) of model space sampling and joint inversion objective functions with different methods in accordance with one or more embodiments. A physics-based inversion (702) is limited by the minimization performed in the vicinity of the starting model and needs a solution given a good guess of the model parameter distribution. This operation may lead to explore only a portion of the model space. A statistics-based deep learning inversion (704) performs a statistical stochastic sampling of the model space. The model to be predicted after the training must be comprised within the probability distribution used during the training.

Both conditions described above are difficult to make happen in real case scenarios; it may be possible to approach the true distribution but the right starting model for the physics-based inversion (702) may not have been guessed or enough training on cases for the deep learning-based inversion (704) may not have been performed. The introduction of the hybrid coupled approach of physics-based and deep learning-based inversions (706) with feedback loop on the training allows the inversion to converge to the true model distribution through an iterative approach (See FIG. 6 and equations 7-10). The discussion above is valid for single domain (single parameter) inversions and for multi domain (multi parameter) joint inversions.

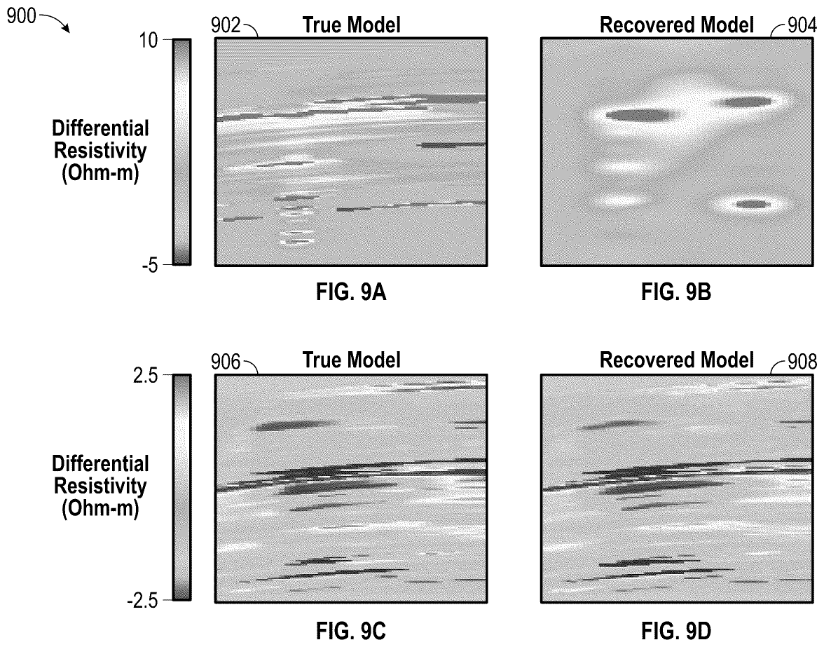

Turning to FIG. 8, FIG. 8 shows an example (800) of single domain objective function and multi-parameter joint inversion objective function in accordance with one or more embodiments. The considerations made for FIG. 8 are valid for any inversion scheme that can be related to geophysical data or other. Additional benefits to the inversion are obtained when multi-parameter inversion is considered instead of a single parameter inversion (802 and 804). This concept is expressed qualitatively by the representation of the objective functions during an inversion process. The objective function describes the behavior of a misfit functional where for non-linear inversion problems it can present several local minima and one global minima. The goal is to obtain the parameter distribution corresponding to the global minima of the objective function. The minimization process of a physics-based inversion may easily end in a local minima (arrows) depending on the choice of the initial model and on the shape of the objective function. The simultaneous minimization of multiple parameters (joint inversion) helps reaching the global minima of the solution (806). A physics-driven deep learning inversion/joint inversion addresses the problems described in FIGS. 8 and 9 enabling a comprehensive exploration of the model space and the minimization of one or multiple parameters to reach the global minima of the inversion process.

Turning to FIG. 9, FIG. 9 shows an example (900) of comparison of inversion results for the same well pair with similar acquisition geometry in accordance with one or more embodiments.

In this example, a black oil fluid flow simulator is used to generate a number of cases through time for training a deep learning network that is later capable of predicting high-resolution distributions of saturation-related resistivity as the result of time-lapse measurements of cross-well electromagnetics (EM). The goal is to track the evolution of the waterflood resulting from production optimization processes, which involve the injection of conductive sea water sweeping resistive oil. In this example, a purely statistical approach is used through deep learning where the network is trained through various saturation cases over the time dimension as generated by a fluid-flow simulator (or reservoir simulator).

FIGS. 9A and 9B show CO₂ injection only (902) and the recovered model from the least-squares standard inversion (904). FIGS. 9C and 9D show Water Alternating Gas (WAG) reservoir true model (906) and recovered model by deep learning inversion (908). As shown in FIG. 9, the machine learning approach is superior to an equivalent physics-driven inversion where the regularization imposed to the solution cause loss of details. In some embodiments, the simulator relies on geological information provided by seismic, production information, rock formation properties from wells that might be insufficient when interpolated or extrapolated to the inter-well space, causing erroneous modeling of the fluid flow in the reservoir. For example, if an undetected fracture zone exists in the space between wells, the training performed with the simulated cases will be insufficient to reconstruct the real pattern of fluid saturations (because the fracture corridor model was not included in the deep learning network training). On another side, a remote sensing method such as cross-well EM may detect the fracture corridor as permeated by conductive fluids (saline water—high conductivity/low resistivity) making a large contrast with the oil-saturated rocks (oil—high resistivity).

Such a situation represents the case where a physics-driven inversion can introduce in the system the expression of the fracture corridor geological feature that was unmodeled in the first instance by the reservoir simulator and not part of the deep learning neural network training. The feedback loop with retraining are useful to expand the knowledge base of the machine learning network allowing better predictions at the following iteration.

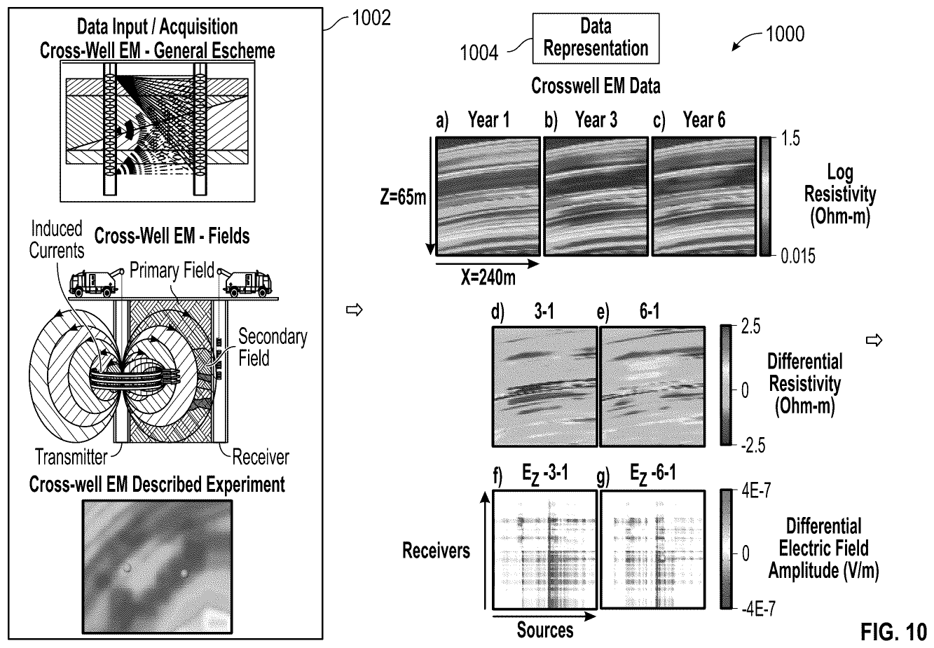

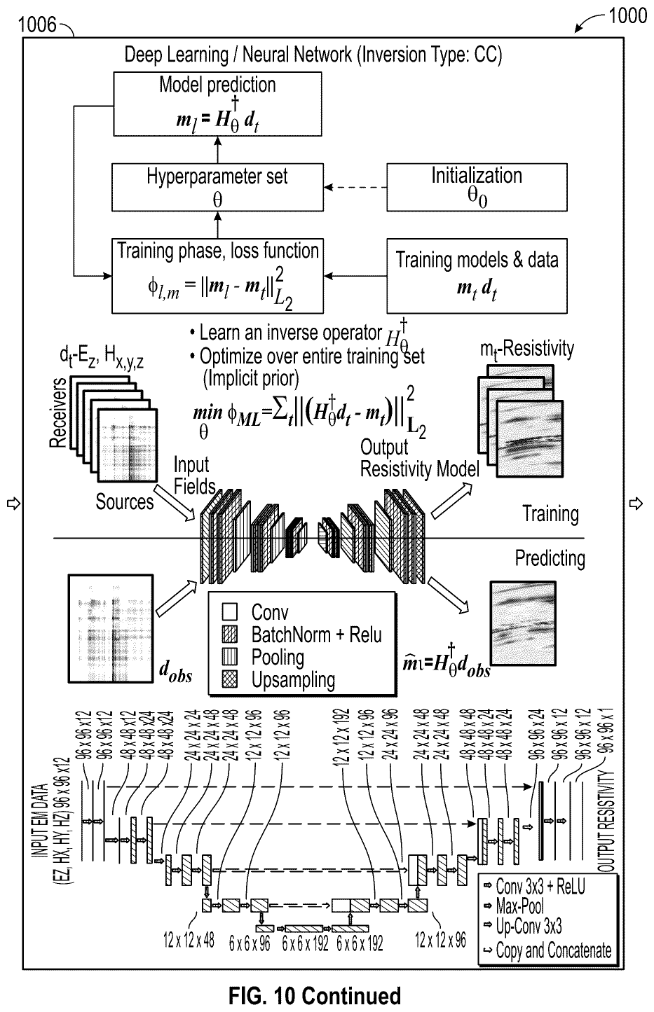

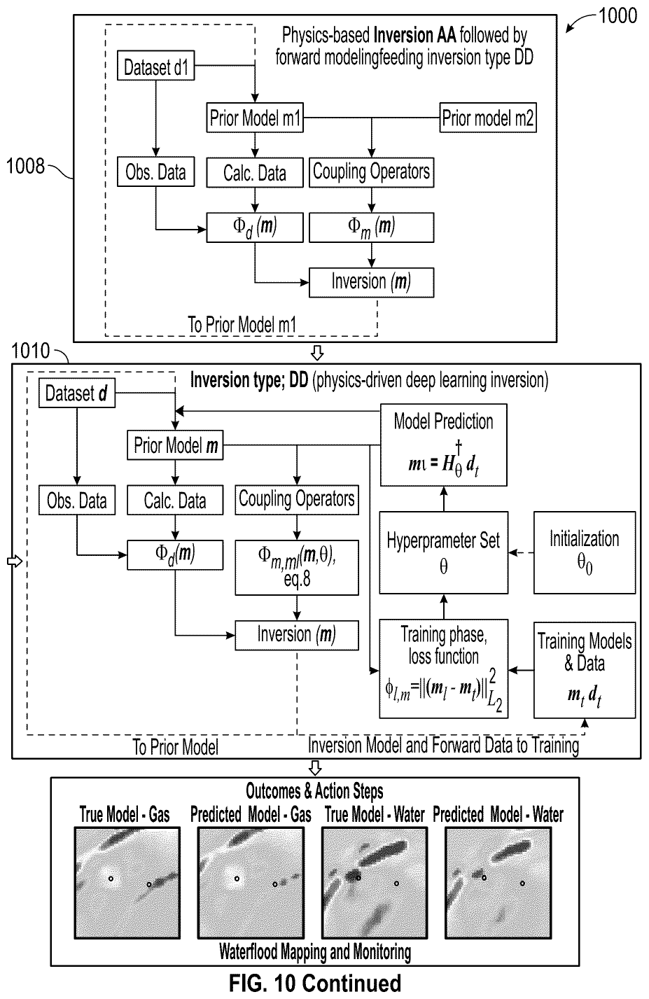

Turning to FIG. 10, FIG. 10 shows an example (1000) of the physics-driven deep learning inversion workflow as applied to the inversion of a synthetic case of cross-well EM monitoring applied to a WAG (water-alternating-gas) EOR realistic simulation in accordance with one or more embodiments.

In some embodiments, the fluid saturations in the reservoir are obtained using a reservoir simulator in which reservoir saturation snapshots are taken at regular time intervals over a period of 10 years. Saturations are then converted into the resistivity parameter using an accurate porosity model and other parameters characteristic of the reservoir.

Acquisition (1002): Crosswell EM consists of transmitting EM signal with variable frequency across two wells where in one well sources are positioned and in the second well EM receivers are recording the transmitted signals. The positioning of sources and receivers is by means of a wireline setup. Schematically, the signals travels from the source to the receivers exploring the interwell space in between the two wells. Both the primary magnetic field generated by the transmitter and the secondary magnetic fields resulting from the induced currents are measured by the four receiver sensors. The method works in the frequency domain and as such, the resistivity structure in between the wells is inferred from the distortions/attenuation of the signal at specific frequencies of transmission. Modifications of this basic setup are possible by using electric dipoles as source and receivers.

The acquisition setup consists of a crosswell EM experiment with two vertical wells (1002) in which the well on the left is the injector and contains the sources, whereas the well on the right is the observation well containing the receiver array. The separation between the two wells is 120 m. The source is represented by a vertical current dipole (Jz) of unit moment with vertical sampling of 1.0 m and a transmitted frequency of 1000 Hz. The receiving setup consists of a 4C sensor array comprising one vertical electric (Ez) and 3C magnetic sensors (Hx, Hy, and Hz). The background color represent resistivity-converted saturations from the fluid flow simulator.

Data representation (1004): Data are represented by the 4C sensor array comprising one vertical electric (Ez) and 3C magnetic sensors (Hx, Hy, and Hz; or Hxyz). For each fluid flow simulation realization, the simulator pillar grid is upscaled into an adaptive 3D finite-difference (FD) mesh and calculate the corresponding EM fields using a 3D FD method. Models and data are differentiated relative to the baseline to focus the attention on the time-lapse changes in resistivity and signal strength. Electric and magnetic responses are concisely represented for each simulated model by plotting amplitude and phase as a function of source (x-axis) and receiver (y-axis) positions. The specific data representation is used to facilitate the task of convolutional neural networks (CNN) of our deep learning scheme. No other specific data pre-processing is performed except differentiation of the resistivity and the EM fields relative to a baseline.

Deep learning inversion (type CC) (1006): Turning to FIG. 10 and to “Deep Learning/Neural Network” (1006), an inversion type CC is implemented where the deep learning network is first trained with simulation models from the reservoir simulator and the corresponding data responses of Ez, Hxyz on a partition of the simulation dataset (for example, 80%) that is used for training and network parameter refinement purposes (validation). The training dataset portion is only used for building the network parameters, and the validation dataset is used to further refine the network parameters. Once the network parameters have been optimized the deep learning network is used to predict the resistivity parameter distribution (model) from observed data (Ez, Hxyz). A specific type of DL network called U-Net is displayed, while the operation performed in terms of flowchart is shown by FIG. 5 (Inversion type CC). It is understood that other types of DL/ML networks may be used. The predicted models are fed into inversion type DD.

Physics-based inversion (type AA) (1008): In the “Physics-based inversion block” (type AA) of FIG. 10, how the cross-well EM data (e.g. amplitude and phase of Ez, Hxyz) is inverted using a typical linearized optimization method based on an initial model (dataset d1/m1) is described. The prior model m1 (FIG. 3A and FIG. 10) may be a simple half-space or can be a more evolved and structured initial guess. For example, the output or prediction from the deep learning inversion (type CC) (1006) may be used as prior model m1. Inversion type AA (1008) also enables the use of a different prior model m2 that can be utilized during the optimization process by means of some penalty functions generically called “coupling operators” (for example, reference model, covariance matrix, gradient-based structure mechanisms, rock-physics, etc.). Such prior model m2 can also be the output of the deep learning prediction (type CC). The result of the physics-based inversion AA (1008) are a set of resistivity models that together their respective forward response calculation are feeding inversion type DD (1010).

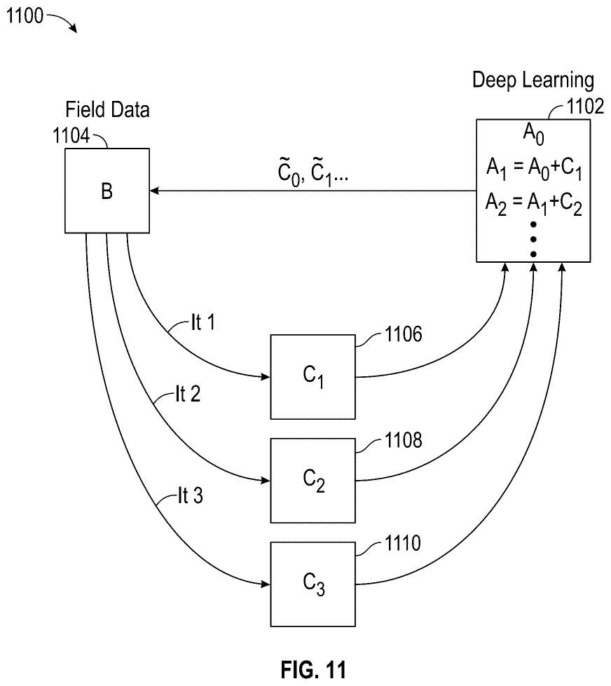

Physics-driven deep learning inversion (type DD) (1010): Turning to FIG. 10 and to “Inversion type: DD (physics-driven deep learning inversion)” (1010), one specific implementation of inversion type DD is explained as an example (1100) in FIG. 11.

FIG. 11 shows three groups of data: A, B, C in accordance with one or more embodiments. Data group A represents the deep learning portion where the model space and associated responses are sampled by performing extended fluid flow simulations through time: for example, 10 years of simulations with a total of 194 simulated fluid models and associated EM responses. At iteration zero, the deep learning network (1102) (after internal training and validation steps) outputs a first prediction of models based on the field data B (1104): ^{˜}C0 (inversion type CC-deep learning).

Data group B (1104) represents the “field data” or in other words the actual EM data responses for the cross-well EM configuration measured and that are mapped into one or multiple model parameter distributions (i.e. inversion process). Data group B does not change during the iterations, as this is the actual dataset that is collected.

Data group C represents the output of the inversion procedure DD at each iteration, hence C1 (1106), C2 (1108), C3 (1110), . . . ,Ci. Group C is composed by models and corresponding forward responses.

In one or more embodiments, the first prediction from deep learning (^{˜}C0) is used in the inversion type AA as prior models (m1, m2 or both: m1=m2). This, through a set of penalty functions generically called “coupling operators” is biasing the inversion of datasets d1. The output of this inversion process represents a first prediction from a physics-driven inversion process type AA biased by inversion process CC, which forms inversion process DD.

After the output of C1 models (parameter distributions) at iteration 1, new forward responses are calculated and the combined model+responses C1 are fed into the deep learning (1102) re-training. Now, the training set for deep learning will be A1=A0+C1 and the new prediction will be ^{˜}C1. The process is then repeated over various iterations to observe the output of inversion type AA (i.e. C2, C3, etc.) as it becomes progressively closer to inversion type CC predictions (i.e. ^{˜}C1, ^{˜}C2, etc.). The described workflow is called inversion type DD.

In some embodiments, a stopping criterion is set by comparing Ci output to ^{˜}Cj prediction. When the two are within some statistical measure threshold it means that the procedure has converged and the output model parameter distribution is “optimal” satisfying at the same time a surrogate of a stochastic sampling of the model space (inversion type CC-data group A) and the deterministic optimization (AA-data group B). This makes the inversion results have better chances than proceeding with independent inversions such as AA or CC.

Referring back to FIG. 11, the outcome of the operation is a high-resolution resistivity model expressing the saturations in the reservoir because of oil production operations. Such a knowledge allows taking better decisions for optimizing oil production and for deciding where to drill infill wells to better drain the oil in the reservoir. The example provided is tailored for the case of cross-well EM but the same workflow can be extended to seismic or other geophysical method with acquisition from the surface, in the borehole and connecting the surface with the borehole.

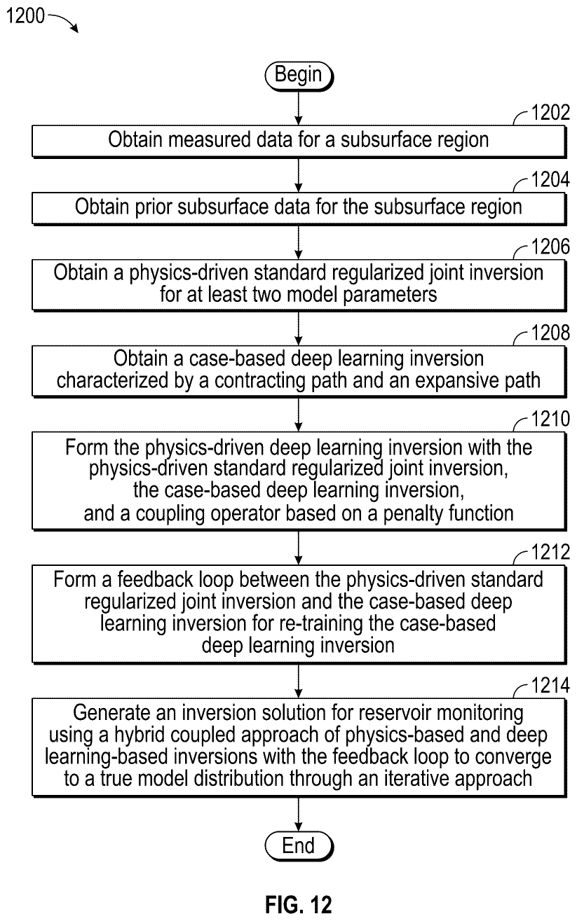

FIG. 12 shows a flowchart (1200) in accordance with one or more embodiments. Specifically, FIG. 12 describes a general method for a physics-driven deep learning-based inversion coupled to fluid flow simulators. One or more steps in FIG. 12 may be performed by one or more components (for example, reservoir simulator (160)) as described in FIGS. 1, 2A, and 2B. While the various steps in FIG. 12 are presented and described sequentially, one of ordinary skill in the art will appreciate that some or all of the steps may be executed in different orders, may be combined or omitted, and some or all of the steps may be executed in parallel. Furthermore, the steps may be performed actively or passively. The method may be repeated or expanded to support multiple components and/or multiple users within a field environment. Accordingly, the scope of the disclosed technology should not be considered limited to the specific arrangement of steps shown in FIG. 12.

In step 1202, acquired measured data is obtained for a subsurface region in accordance with one or more embodiments. For example, the acquired well data may correspond to well logs obtained for an interval of interest using a logging system (112) or logging tools (113) described previously in FIG. 1 and the accompanying description. Remote sensing techniques such as geophysical methods (e.g., seismic, gravity, electromagnetics) rely on the measurement of “fields” (e.g., travel-time/amplitudes, gravity acceleration, electric/magnetic fields) from “remote” locations such as the subsurface structures or other boreholes. For example, during a seismic survey, one or more seismic sources generate seismic energy (for example, a controlled explosion, or “shot”) which is delivered into the earth. Seismic waves are reflected from subsurface structures and are received by a number of seismic sensors or “receivers” (e.g., geophones). The seismic data received by the seismic sensors is processed in an effort to create an accurate mapping of the subsurface region. The processed data is then examined (for example, analysis of images from the mapping) with a goal of identifying subsurface structures that may contain hydrocarbons. The seismic data further provide the knowledge of the relations between rock properties (e.g., P-velocity/S-velocity, density, resistivity, porosity, saturations, etc.) and corresponding measured fields given certain conditions (e.g., geometry of acquisition, other rock properties, etc.).

In step 1204, prior subsurface data is obtained for the subsurface region in accordance with one or more embodiments. For example, the fluid saturations in the reservoir are obtained through the use of the reservoir simulator (160) in which reservoir saturation snapshots are taken at regular time intervals over a period of 10 or more number of years. Saturations are then converted into the resistivity parameter using an accurate porosity model and other parameters characteristic of the reservoir for the subsurface region.

In step 1206, a physics-driven standard regularized joint inversion for at least two model parameters (for example, the physics-driven standard regularized joint inversion (350)) is obtained in accordance with one or more embodiments. However, the general scheme can be equally formulated for a case of the inversion of a single model parameter (300) or for the case of joint inversion (350) of multiple parameters described previously in FIGS. 3A-3B and the accompanying description.

In step 1208, a statistics-based deep learning inversion characterized by a contracting path and an expansive path (for example, the statistics-based deep learning inversion (500)) in accordance with one or more embodiments. For example, the statistics-based deep learning inversion is composed by two steps consisting of a training phase where the network hyperparameters are learned from input data and models, and a testing phase (prediction) where the optimized pseudoinverse operator is used to predict the models using observed data described previously in FIGS. 4-5 and the accompanying description. However other types of convolutional neural networks or other machine learning methods can also be implemented to apply the described workflow

In step 1210, the physics-driven deep learning inversion is formed in accordance with one or more embodiments. For example, the physics-driven deep learning inversion (600) is formed with the physics-driven standard regularized joint inversion, the statistics-based deep learning inversion, and a coupling operator based on a model reference term described previously in FIG. 6 and the accompanying description. The model reference term is acting as a coupling operator where the structure and rock-physics operators of equation 1 are now implicitly learned through the deep learning neural network and may not need to appear as separate terms in the statistics-based deep learning joint inversion objective function (equation 7). The method for physics-driven deep learning inversion can be equally applied to single domain inversion (for example, single data-single parameter) as well as to multiple domain inversion (for example, multiple data-multiple parameter, or joint inversion).

In step 1212, a feedback loop between the physics-driven standard regularized joint inversion and the statistics-based deep learning inversion is formed in accordance with one or more embodiments. For example, the feedback loop (610) of the physics-driven deep learning inversion (600) is formed for re-training the statistics-based deep learning inversion. The output of the statistics-based deep learning inversion (for example, inversion model and corresponding forward modeled data) are added to the training dataset for further re-training of the network. The results of the inversion are also sent to update the prior model of the physics-driven standard regularized joint inversion described previously in FIG. 11 and the accompanying description.

In step 1214, an inversion solution for reservoir monitoring is generated in accordance with one or more embodiments. For example, the inverse solution (for example outcomes and action steps (1012) generated using a hybrid coupled approach of physics-based and deep learning-based inversions (1010) with the feedback loop to converge to a true model distribution through an iterative approach described previously in FIG. 10 and the accompanying description. In one or more embodiments, the workflow enables to perform high resolution mapping and monitoring of saturations in the reservoir by coupling the response of resistivity generated from a fluid flow simulator with geophysical measurements. The fluid flow simulator, being a forward process, is conditioned by the initial assumptions made. The introduction of geophysical measurements and deep learning techniques with network re-training allows to enhance the estimates and incorporate cases that deviate from the original assumptions. The outcomes of such a procedure are a better reservoir monitoring enhancing reservoir management operations, hence more oil production with less costs and reduced risks of drilling wells not finding oil (i.e. finding water instead).

The approaches described are just examples of practical implementations of the developed methodology in specific cases related to geophysical inverse problems or in other words the group of methods designed to reconstruct parameter distributions from observations of measurable data that are typically described by non-linear functions of the model parameters. It is well understood that the flowchart discussed in FIG. 12 is equally applicable to single-parameter inversion as well as to multiple-parameter coupled inversion (joint inversion).

One final consideration is that the example provided for the geophysical cases described represents only a fraction of the possible applications in the geophysical domain. The applications of the developed methodology to the whole geophysical domain represent a fraction of the applications that can be performed for all the other science, engineering, finance, medical, etc. fields.

The following examples are provided to illustrate, but not limit, the present disclosed embodiments.

The described approaches of deep learning inversion work well when sufficient and comprehensive sampling of the model space has been performed. In this way, the model space may be represented through stochastic sampling and inferring the missing points by means of the trained statistical network. Such approaches are also named “big data analytics” methods because they work well when the statistical base (for example, the key words used in an internet search engine) is big enough. For geophysical applications, as per other fields of science, engineering, finance, and/or other fields of study, a large statistical base may not be readily available. In such situations, machine learning or deep learning approaches may be limited in scope as the training performed may be specific to the particular application (that is, there is a limited model space) and the network parameters built in this way may be biased. In this case, the main benefits described by ML inversion may be lost, or the derived network parameters may be too local with limited “generalization” capability to be applied to new and different datasets. By joining a physics-based approach to the machine learning approach, the training base may be expanded, as described by relative to FIGS. 8-10 above. Several applications may be implemented for geophysics and other fields, per the following examples.

### Example 1: Transient Electromagnetics (TEM) Inversion

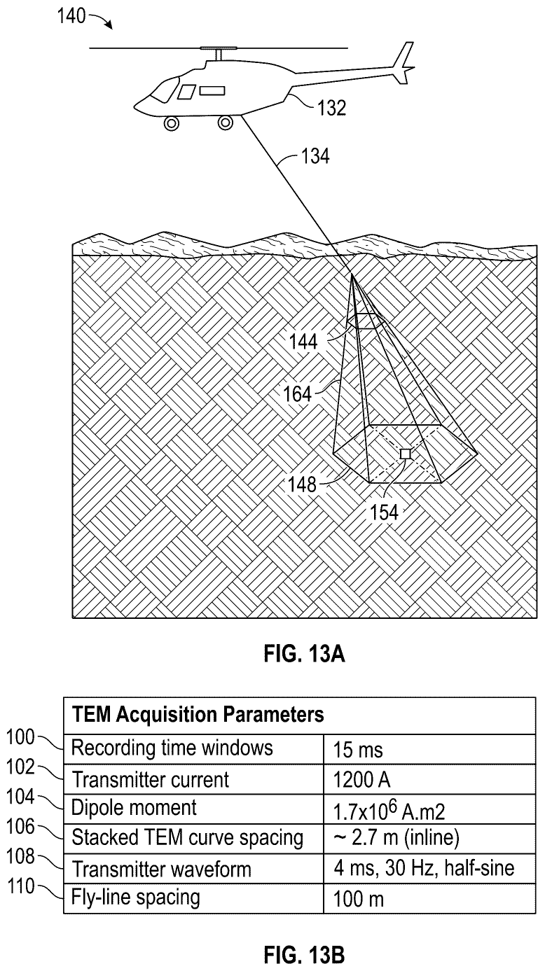

Referring to FIGS. 13A-15, the first example relates to the collection of magnetic and resistivity properties of a geologic formation or reservoir. Transient Electromagnetic (TEM) soundings (Colombo et al., 2016) are acquired to explore the shallow subsurface (that is, the near-surface) of a geologic formation or reservoir with high resolution. The applications may include water resource assessment, or as in Colombo et al. (2016), to derive a high-resolution description of the near surface for seismic corrections, a process that can be performed by means of joint inversion of seismic and TEM data (Colombo and DeStefano, 2007; Colombo et al., 2016). The dense spatial sampling of helicopter-borne TEM methods (one of the several implementations of airborne TEM measurements) provides an accurate description of the near-surface in terms of resistivity that is then mapped to seismic velocity for near-surface corrections by the discussed process of joint inversion.

Referring to FIG. 13A, the method and/or system 140 may include a source loop 148 hanging below an aircraft such as a helicopter 132. A large ampere DC current is circulated through the source loop 148, and a receiving loop 144 acts passively as a receiving device. In one embodiment, the receiving loop 144 is located above the source loop 148 while in another embodiment, the receiving loop 154 may be coplanar with the source loop 148. The DC current is then abruptly interrupted and such time transient induces a time-varying (primary) vertical magnetic field generating (by the process of electromagnetic induction, that is, Faraday's law) secondary electrical currents called “Eddy” currents that circulate in the ground and progressively propagate deeper into the subsurface. The existence and propagation of such induced Eddy currents are related to the conductivity (or resistivity, which is the inverse of conductivity) of the ground, with more conductive rocks allowing a longer time for Eddy current dissipation, and more resistive rocks causing the rapid decay of the Eddy currents. Such a time variation of Eddy currents causes a corresponding (secondary) time-varying magnetic field (dBz/dt) (per Ampere's law). Such secondary field is what is measured by the receiving loop 144, 154 on the helicopter 132. The rate of time decay of the secondary field dBz/dt is then used to infer the distribution of the resistivity parameters (Rho) vs depth through a process of inversion (1D inversion for simplicity in this case; other embodiments may include 2D, 3D, or higher dimensional inversions).

Referring still to FIG. 13A, the transient electromagnetics (TEM) system 140 may also include a hoist, line, rope, and/or main cable 134 for coupling the various hanging components of the system 140 to the helicopter 132. In some embodiments, the source loop 148 and/or the receiving loop 144 may include circular, hexagonal (as shown in FIG. 13A), and/or other suitably shaped configurations. The system may also include multiple support cables 164 connecting the vertices of the source loop 148 with the main cable 134. Each of the support cables 164 and the main cable 134 may include one or more communication lines and/or one or more electrical lines, in addition to providing structural support.

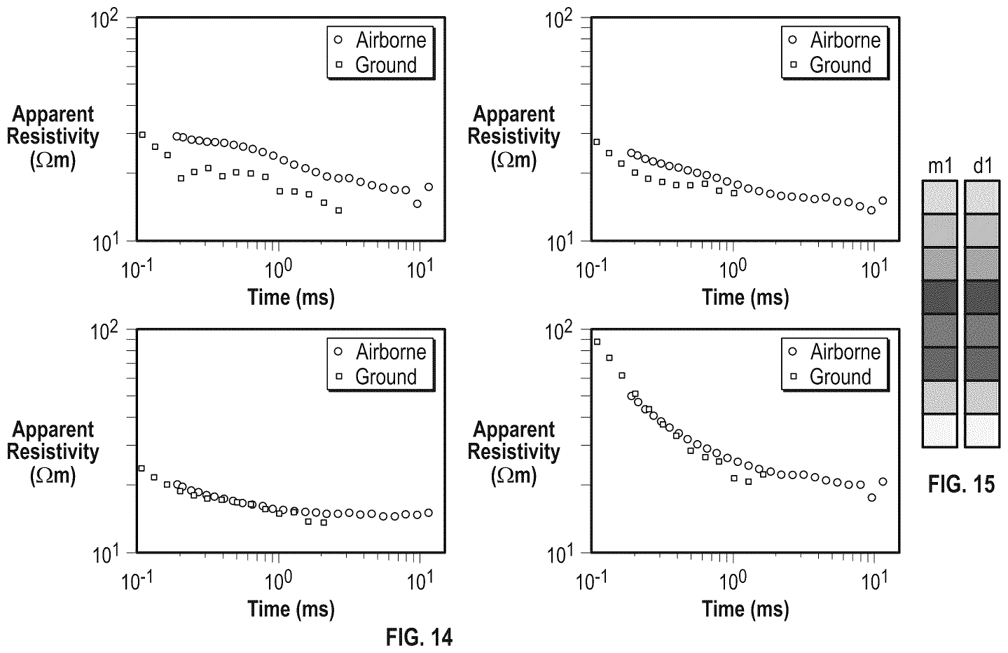

Referring still to FIGS. 13A-15, an example of helicopter-borne TEM acquisition parameters are shown in FIG. 13B, and may include the recording time windows 100, the transmitter current 102, the dipole moment 104, the stacked TEM curve pacing 106, the transmitter waveform 108, the fly-line spacing 110. For example, the transmitter current 102 in the source loop 148 may be about 1200 A, the recording time windows 100 may be 15 ms (milliseconds) or from about 5 ms to about 30 ms, and the fly-line spacing 110 may be about 100 m. Similarly, the dipole moment 104 may be 1.7×10⁶ A.m², the stacked TEM curve spacing 106 may be about 2.7 m, the transmitter waveform may be 4 ms in duration, 30 Hz in frequency, and half-sine shaped. The data corresponding to the helicopter-borne TEM vs ground-based TEM (often also called TDEM, “Time-Domain EM”) is shown by FIG. 14, where the dBz/dt measurements are converted for ease of representation to a quantity called “apparent resistivity.” FIG. 14 illustrates a comparison of helicopter-borne and ground-based TEM soundings at corresponding spatial locations. The helicopter-TEM shows better stability at longer acquisition times due to larger currents circulating in the source loop 148. The data representation for the already described deep learning network in FIGS. 4-8 may be represented for the 1D (one-dimensional) case by two vectors of models and data (illustrated in FIG. 15, which is a representation of a model vector and a data vector feeding the deep learning network of FIGS. 4-8). The model vector contains the ground resistivities at different depths; the data vector contains the TEM measurements at different acquisition times. The comparison of airborne TEM vs. ground-based TDEM allows for confidence to be gained in the airborne TEM (for example, thereby allowing potential sources of variation in the airborne TEM system 140 to be identified and rectified). The airborne TEM system 140 may then be used to collect data over a wide area more quickly, and unhindered by ground-based obstructions.

Still referring to FIGS. 13A-15, the standard approach for TEM data inversion, on the other hand, may be based on an optimization technique formulated as “least squares” and using “conjugate gradients”, where the solution is sought around a starting model by defining an objective function of data misfit 33 (shown in FIG. 8) and regularization terms (that is, the first two terms in equation (1) in Colombo et al., 2016: Phia (m) and Phim (m)), and by taking the gradient of such objective function versus the model parameters. Such an approach is biased by the starting model chosen at the beginning. The equivalent ML/DL approach may suffer from the limited stochastic sampling (that is, statistics-based sampling) being insufficient to cover the probability distribution of both the model and data spaces, as discussed above. The implementation of the physics-based and statistics-based deep learning joint inversion approach of FIG. 8 addresses the two described limitations simultaneously.

### Example 2: Seismic Acquisition (Reflection Seismology)

Full waveform inversion (FWI) may be used to invert the seismic wave equation for the velocity structure (see Tarantola, 1984; Virieux and Operto, 2009 for a comprehensive review). The FWI technique is high resolution but suffers from the local optimization techniques typically used. In addition, the effect of noise makes FWI a process difficult to implement, especially for land seismic data. In order to obtain quality results, an initial velocity model, sufficiently close to the ground truth, must usually be provided as an input. An additional challenge is the high computational cost associated with 3D implementations of FWI. In one specific realization of the FWI process, a 1.5D solution may be implemented such that the wave equation is 3D but inverted into a 1D velocity structure (that is, laterally invariant but varying vertically). The specific implementation described may be in the Laplace-Fourier domain (Shin and Ho Cha, 2009; Petrov and Newman, 2012; and/or Rivera et al., 2015). For acoustic, isotropic and constant density 1D media the inhomogeneous Helmholtz equation in the Laplace-Fourier (LF) domain in Cartesian coordinates is given by:

$$[ {∇}^{2} - {k ( z )}^{2} ] \tilde{u} ( x , s ) = \tilde{f} ( x , s ) , \qquad ( 11 )$$

where x=(x, y,z) and s=σ+jω is the Laplace-Fourier complex frequency defined by a damping component σ and an angular frequency component ω, with \sqrt{j=v−1.}k(z)=s/c (z), where c(z) is the 1D compressional velocity profile defining the 1D acoustic medium and \tilde{f}(x, s), ũ(x,s) are the forcing term (f(x, t)) and modelled wave-field (u(x, t)), respectively, transformed to the Laplace-Fourier domain. The forward transform from the time domain to the Laplace-Fourier domain is given by:

$$\tilde{u} ( x , s ) = {\int }_{0}^{∞} u ( x , t ) {e}^{- st} dt . \qquad ( 12 )$$

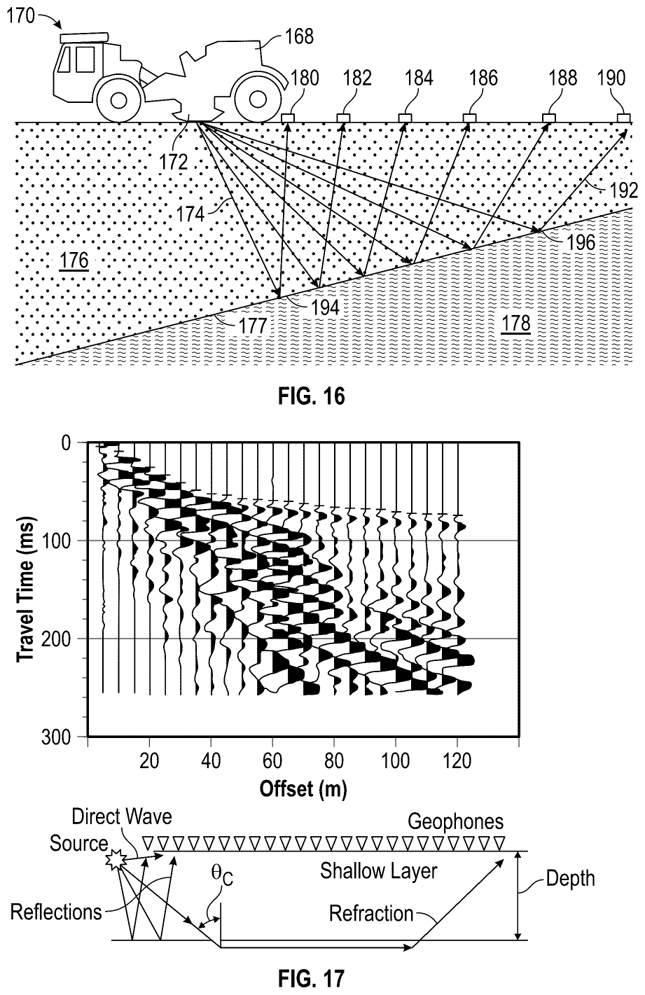

FIG. 16 illustrates an exemplary seismic acquisition system 170 that may be used for reflection seismology, which involves transmitting energy into the ground (or formation) and using receivers (for example, geophones and/or other acoustic receivers) to measure reflections and/or refractions of the transmitted energy as they permeate through the formation (for example, a geologic formation), which can be used to determine various properties of the formation. The seismic acquisition system 170 may include one or more truck-based systems including one or more Vibroseis trucks 168 which may include a real-time kinetic (RTK) positioning system that enables the Vibroseis truck 168 to be accurately positioned at a given source location. The Vibroseis trucks 168 may include various methods for creating the energy that is transmitted into the formation including, but not limited to, via Tovex blast, air gun, seismic vibrator 172, and/or Vibroseis. As energy is transmitted into the near surface of the formation by the Vibroseis trucks 168 (for example, via a first wave 174 that permeates through a first layer 176 of the formation), a portion of the first wave 174 may reflect off of a first location 194 of an interface 177 (defining the boundary of the first layer and a second layer 178 of the formation). The reflected portion of the first wave 174 may then be measured by a first geophone 180, which is positioned at the surface a linear distance from the seismic vibrator 172. Similarly, a second wave (adjacent the first wave) may reflect off the interface 177 (at a different location than that of the first wave 174) such that it may be received by a second geophone 182 located at a second distance from the seismic vibrator 172. Similarly, third, fourth, fifth, and/or other waves (including the reflected portion 192 of the sixth wave, which reflects off of a sixth location 196 of the interface 177) are reflected off the interface 177, and received by the third, fourth, fifth, and sixth geophones 184, 186, 188, 190. Portions of each wave may also refract into the second layer 178. The readings and measurements from the geophones 180, 182, 184, 186, 188, 190 may then be used to compute travel times of each wave within the first layer 176 which may be used to determine the characteristics of the interface 177 (for example, depth, dimensions, and orientation) as well as the velocities of the waves within the first layer 176 (computed from travel times and distance of travel), which in turn may be used to determine characteristics of the formation (for example, density, composition, resistivity, etc.)

Referring still to FIG. 16, the system 170 may include more than six (6) geophones 180, 182, 184, 186, 188, 190 and may include geophones 180, 182, 184, 186, 188, 190 that are arranged in other configurations such as two-dimensional arrays at the surface with multiple concentric arrays of geophones at varying distances from the seismic vibrator(s) 172. FIG. 17 illustrates a diagram of travel times plotted against offset, which can be used to compute the velocities of the energy waves within the formation. FIG. 17 also diagrammatically illustrates both seismic reflection, as well as seismic refraction.

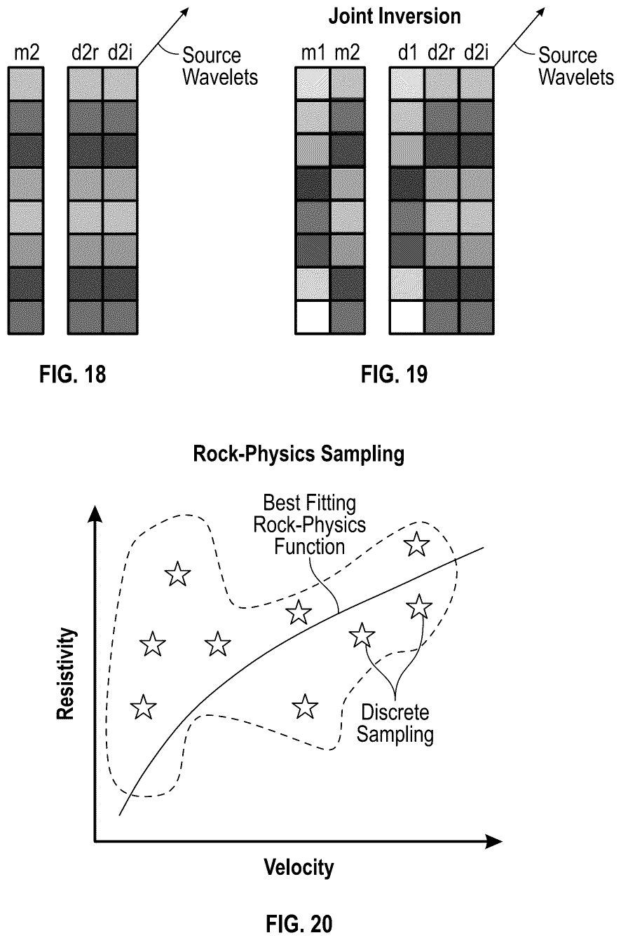

Referring to FIGS. 16, 17, and 18, the local optimization of the FWI inversion problem is similar to the case of TDEM inversion where an objective function composed by at least a data misfit term and a model regularization term are least squares jointly minimized in search of an optimal solution. The inversion problem however suffers from high non-linearity and non-uniqueness of the results that are typically expressed by the solution ending in one of several “local minima” rather than the “global minimum” of the objective function. Similar considerations hold for the FWI case as per the TEM inversion case and the solution may also be sought through a ML/DL approach, where the model and the data structures for the specific case of LF-FWI, as shown in FIG. 18 (which illustrates a representation of a model vector and a data tensor feeding the deep learning network of FIGS. 4-8). The model vector represents the velocity (or slowness, the inverse of velocity) parameter versus depth and the data tensor is represented by the real and imaginary components of the LF transform, where the variability of the source wavelet is also accounted for.

Referring still to FIG. 18, similar considerations discussed for the TEM inversion apply for FWI (for example, LF in this case). The local minimization approach is biased by the starting model chosen at the beginning of the process. The equivalent ML/DL approach may suffer from the limited stochastic sampling (that is, statistics-based) being insufficient to cover the probability distribution of model and data spaces, as discussed above. The implementation of the physics-based and statistics-based deep learning joint inversion approach of FIG. 8 addresses the two described limitations simultaneously.

### Example 3: Joint Inversion of TEM and Seismic Models

The third example may be represented by the joint inversion of transient EM (TEM) data and seismic data (LF transform in this specific case: LF-FWI). The idea behind joint inversion is that the combination of different geophysical parameters and measurements describing the common underlying geology allows for the further limiting of the non-uniqueness of the solution. In other words, the range of models fitting multiple data is less than proceeding separately with each independent method (thereby eliminating multiple subsets of inaccurate models). In this specific implementation, different earth parameters (resistivity and velocity in this case) may change at common boundaries, or, in other words, the change of parameters is controlled by the underlying geology. This assumption is reasonable and verified by experimental observations. In addition to data and model structures that are now generically represented by tensors, a sampling of possible rock-physics values may be defined connecting the resistivity and velocity parameters as shown in FIGS. 19 and 20, which illustrate a representation of model and data tensors feeding the deep learning networks 52 of FIGS. 4-8.

As discussed above, the local minimization approach is biased by the starting model chosen at the beginning of the process even if, as in this case, the non-uniqueness is mitigated by the presence of additional regularization terms in the joint inversion objective function linking different domains (see Colombo et al., 2016-equation (1)). The equivalent ML/DL approach may suffer from the limited stochastic sampling (that is, statistics-based) being insufficient to cover the probability distribution of model and data spaces, as discussed above. The implementation of the physics-based and statistics-based deep learning joint inversion approach of FIG. 8 addresses the two described limitations simultaneously.

In addition to the above examples, the physics-based and statistics-based deep learning joint inversion methodologies and systems of the present disclosed embodiments may be applied to computational fluid dynamics, personal health modeling, public health, energy exploration, power generation, aviation, shipping, warehousing, transportation, climate change modeling, economic modeling, research and development, construction, enterprise resource management, education, automotive applications, as well as other applications. The approaches and examples described herein are examples of practical implementations of the developed methodology in specific cases related to geophysical inverse problems (or in other words, the group of methods designed to reconstruct parameter distributions from observations of measurable data that are typically described by non-linear functions of the model parameters). The present disclosed embodiments provide examples of single domain inversion (TEM and FWI as separate inversions), as well as joint inversion (TEM and FWI joint inversion). The present disclosed embodiments are applicable to single-parameter inversion as well as to multiple-parameter coupled inversion (joint inversion). The geophysical cases described represent only a fraction of the possible applications in the geophysical domain (and nearly infinite potential applications outside of the geophysical domain). The applications of the developed methodology to the whole geophysical domain represent a fraction of the applications that can be performed for all the other science, engineering, finance, and medical fields of study, as well as other fields of study.

All or part of the system and processes described in this specification and their various modifications (subsequently referred to as “the processes”) may be controlled at least in part by one or more computing systems using one or more computer programs. Examples of computing systems include, either alone or in combination, one or more desktop computers, laptop computers, servers, server farms, and mobile computing devices such as smartphones, feature phones, and tablet computers.

Embodiments may be implemented on a computing system. Any combination of mobile, desktop, server, router, switch, embedded device, or other types of hardware may be used. For example, as shown in FIG. 21A, the computing system (1300) may include one or more computer processors (1302), non-persistent storage (1304) (for example, volatile memory, such as random access memory (RAM), cache memory), persistent storage (1306) (for example, a hard disk, an optical drive such as a compact disk (CD) drive or digital versatile disk (DVD) drive, a flash memory), a communication interface (1312) (for example, Bluetooth interface, infrared interface, network interface, optical interface), and numerous other elements and functionalities.

The computer processor(s) (1302) may be an integrated circuit for processing instructions. For example, the computer processor(s) may be one or more cores or micro-cores of a processor. The computing system (1300) may also include one or more input devices (1310), such as a touchscreen, keyboard, mouse, microphone, touchpad, or electronic pen.

The communication interface (1312) may include an integrated circuit for connecting the computing system (1300) to a network (not shown) (for example, a local area network (LAN), a wide area network (WAN), such as the Internet, mobile network, or any other type of network) or to another device, such as another computing device.

Further, the computing system (1300) may include one or more output devices (1308), such as a screen (for example, a liquid crystal display (LCD), a plasma display, touchscreen, cathode ray tube (CRT) monitor, or projector), a printer, external storage, or any other output device. One or more of the output devices may be the same or different from the input device(s). The input and output device(s) may be locally or remotely connected to the computer processor(s) (1302), non-persistent storage (1304), and persistent storage (1306). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s) is configured to perform one or more embodiments of the disclosure.

The computing system (1300) in FIG. 21A may be connected to or be a part of a network. For example, as shown in FIG. 22B, the network (1320) may include multiple nodes (for example, node X (1322), node Y (1324)). Each node may correspond to a computing system, such as the computing system shown in FIG. 21A, or a group of nodes combined may correspond to the computing system shown in FIG. 21A. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (1300) may be located at a remote location and connected to the other elements over a network.

Although not shown in FIG. 22B, the node may correspond to a blade in a server chassis that is connected to other nodes via a backplane. By way of another example, the node may correspond to a server in a data center. By way of another example, the node may correspond to a computer processor or micro-core of a computer processor with shared memory or resources.

The nodes (for example, node X (1322), node Y (1324)) in the network (1320) may be configured to provide services for a client device (1326). For example, the nodes may be part of a cloud computing system. The nodes may include functionality to receive requests from the client device (1326) and transmit responses to the client device (1326). The client device (1326) may be a computing system, such as the computing system shown in FIG. 21A. Further, the client device (1326) may include or perform all or a portion of one or more embodiments of the disclosure.

While the disclosure has been described with respect to a limited number of embodiments, those skilled in the art, having benefit of this disclosure, will appreciate that other embodiments can be devised which do not depart from the scope of the disclosure as disclosed. Accordingly, the scope of the disclosure should be limited only by the attached claims.

1.-25. (canceled)

26. A method comprising:
obtaining, using a sensor, measured data for a subsurface region comprising a reservoir;
initializing, using a computer system, a model of the subsurface region;
performing inversion comprising iteratively, using the computer system, until a criterion is met:
inputting the measured data into a trained supervised machine learning network, producing a predicted model from the trained supervised machine learning network in response to the measured data,
determining, using a coupling operator, a coupled model based on the model and the predicted model,
forming an objective function based on the coupled model,
determining the value of the objective function,
updating the model based on the value,
determining simulated data by applying forward modeling to the updated model, and retraining the trained supervised machine learning network based on the updated model and the simulated data;
determining, using the computer system, a recovery operation based on the updated model;
injecting, via an injection well, a fluid into the reservoir based on the recovery operation; and
producing, via a production well, production from the reservoir.

27. The method of claim 26, wherein the trained supervised machine learning network comprises a neural network.

28. The method of claim 26, wherein the measured data comprises seismic data.

29. The method of claim 26, wherein determining the value of the objective function comprises alternatively determining a first value of the objective function and a second value of the objective function.

30. A system comprising:
a computer system configured to:
receive, from a sensor, measured data for a subsurface region comprising a reservoir, initialize a model of the subsurface region,
perform inversion comprising iteratively, until a criterion is met:
input the measured data into a trained supervised machine learning network;
produce a predicted model from the trained supervised machine learning network in response to the measured data;
determine, using a coupling operator, a coupled model based on the model and the predicted model;
form an objective function based on the coupled model;
determine the value of the objective function;
update the model based on the value;
determine simulated data by applying forward modeling to the updated model; and
retrain the trained supervised machine learning network based on the updated model and the simulated data, and
determining a recovery operation based on the updated model;
an injection system configured to inject, via an injection well, a fluid into the reservoir based on the recovery operation; and
a production system configured to produce, via a production well, production from the reservoir.

31. The system of claim 30, wherein the trained supervised machine learning network comprises a neural network.

32. The system of claim 30, wherein the measured data comprises seismic data.

33. The system of claim 30, wherein the computer system configured to determine the value of the objective function comprises to alternatively determine a first value of the objective function and a second value of the objective function.
